(19) United States
(12) Patent Application Publication
(10) Pub. No.: US 2007/0232202 A1
(43) Pub. Date: Oct. 4, 2007

(54) Grinding wheel, machine tool with grinding wheel and a method for grinding cutting tools

(75) Inventor: Jurg Schneeberger, Langenthal (CH)

Correspondence Address: BIRCH STEWART KOLASCH & BIRCH, PO BOX 747, FALLS CHURCH, VA, 22040-0747, US

(73) Assignee: J. Schneeberger Holding AG, Roggwil (CH)

(21) Appl. No.: 11/724,258

(22) Filed: Mar. 15, 2007

(30) Foreign Application Priority Data
Mar. 15, 2006 (EP) 06 405 116.2

(51) Int. Cl. B24B 1/00; B23F 21/03

(52) U.S. Cl. 451/45; 451/541

(57) ABSTRACT

In the case of the grinding wheel (1) for grinding cutting tools and in the case of a tool grinding machine using such grinding wheels, the circumference of the grinding wheel (1) is formed as a peripheral ridge (5) with roof sides (3a, 3b) converging toward it, each having an abrasive coat (7a, 7b) (=double-cone wheel). Concave radii of a surface contour region (14) of the cutting tool can be ground with the ridge (5) and/or in each case one of the roof sides (3a, 3b) and all the convex contour regions can be ground with in each case one of the two roof sides (3a, 3b).

Dressing of such a grinding wheel (1) is possible on the same machine tool that is used for grinding the tool. A grinding machine with such a double-cone wheel provides good workpiece accessibility, no problems with clamping means and machine paths that are small. The fitting of the machine with a number of wheels (for example coarse-grained for roughing and fine-grained for smoothing) is possible without any collisions occurring.

### TECHNICAL FIELD

The invention relates to a grinding wheel, a machine tool and a method for grinding cutting tools.

### PRIOR ART

Cup wheels, contour wheels, peripheral wheels and mounted wheels have been used for grinding cutting tools. Flap wheels are not generally used for grinding cutting tools; they are typically used for stripping paint and removing rust.

Cup wheels are formed as a straight frustum of a cone, grinding being performed at the edge of the large upper base side. There are cup wheels with a straight cup and cup wheels with a sloping cup. Both types of cup wheel have an inner recess. The cup wheel with the sloping cup is formed as an internally hollow frustum of a cone. An abrasive coat is arranged on the edge of the base. The cup wheel with the straight cup is likewise hollow on the inside and consequently has a U-shaped cross section, the abrasive coat being arranged on the end faces of the legs of the U. Both types of wheel are formed such that they are rotationally symmetrical, the axis of symmetry being the axis of rotation.

The grinding edge may take various forms. Disadvantages of cup wheels are a long adjustment path and a 180° rotation of the workpiece when opposite grinding locations have to be ground with one and the same cup wheel. On account of the geometry of the wheel, a working process is normally limited to the use of a single grinding wheel; otherwise, workpiece clamping means or machine parts would collide with the wheel bodies.

Peripheral wheels, also known as circumferential wheels, may be formed as wheels with a peripheral abrasive coat arranged parallel to the axis of rotation. On account of the orientation of the abrasive coat in relation to the body of the wheel, relief grinding is difficult to carry out. Concave radii can be ground at most only up to a quarter circle.

Instead of a peripheral wheel edge that runs parallel to the axis of rotation, contour wheels have a conically converging wheel edge with a rounded-off (toroidal) tip. Grinding only takes place with the toroidal contour, it also being possible for relief grinding to be performed. The total tool path of the precise toroidal contour is very limited; precise dressing of these wheels is not possible on the grinding machine.

A mounted wheel is generally formed in a way analogous to a milling cutter that can be clamped in a chuck, an abrasive coat being arranged in place of the cutting edges.

### SUMMARY OF THE INVENTION

Problem

The problem of the invention is to provide a device and a method for grinding cutting tools, by which any concave and complex profiles can be ground with one and the same grinding wheel, and with the intention that it should be possible for a grinding wheel used for grinding to be dressed on the same machine tool that is used for grinding the tool.

Solution

The solution to the problem is provided by the features of patent claim 1 concerning a grinding wheel, by the features of patent claim 4 concerning a machine tool with such a grinding wheel and by the features of patent claim 9 concerning a grinding method. Preferred embodiments of the invention are provided by the features of the dependent patent claims.

In the case of a grinding wheel according to the invention for grinding cutting tools, the circumference of the grinding wheel is formed as a peripheral ridge with roof sides converging toward it and each having an abrasive coat. Concave radii of a surface contour region of the cutting tool can be ground with the ridge and/or respectively with one of the roof sides, and all the convex contour regions can be respectively ground with one of the two roof sides. It goes without saying that the convexly formed surface contour regions could also be ground with the ridge; however, greater precision and speed are obtained by using one of the roof sides in each case. The grinding wheel according to the invention may be characterized as a circumferential wheel, in the case of which the circumferential side provided with an abrasive coat is no longer a lateral outer side of a circular cylinder, but instead two circumferential sides now converge, forming an angle in cross section, by analogy with the ridge of a roof.

The grinding wheel is typically coated with diamond or cubic boron nitride as the abrasive material; it goes without saying that other abrasive materials may be used within the scope of the invention. Cutting tools are for the most part profiled interchangeable tips or profiled rotating tools, but are not restricted to these.

The axis of symmetry of the grinding wheel is at the same time its axis of rotation. The grinding wheel is preferably formed as a double-cone wheel (V-shaped grinding wheel), the two cone axes coinciding and forming the axis of rotation. The small face of each cone may then be a plane extending perpendicularly in relation to the axis of rotation; but it does not have to be. The two faces may be planar, or formed with outer or inner curvatures, one symmetrical to the other or different from each other.

Apart from requirements in terms of mechanical stability, the thickness of the grinding wheel is based on the surface profile radii to be ground or the depth and width of the profiled pockets of the tool to be ground. The double-cone lateral faces or roof sides are made to converge at an angle of less than 90°; with preference, this roof ridge angle is typically chosen to be 60°; it goes without saying that it is also possible to choose smaller angles, in particular less than 30°. For reasons concerning collision, the roof ridge angle is chosen to be about 10% smaller than the smallest angle of concave surface contour regions to be ground. Within this limit, the angle is chosen to be as large as possible, to obtain maximum stability. This stability includes the mechanical stability of the grinding wheel and a geometrical stability of the roof ridge or of the torus that is produced once it becomes worn. Grinding is then respectively performed with one of the roof sides (lateral sides of a cone) and/or with the roof ridge (tip). Thanks to the angled orientation of the abrasive coat in relation to the wheel body and thanks to the slender wheel geometry, relief grinding can also be carried out. The thickness of the grinding wheel and the roof ridge angle determine how deep and how narrow relief grinding can be performed.

Dressing is very simple, since only the roof sides, which are generally planar, have to be worked.

The tip is generally very sharp after dressing. If it is used for grinding, it becomes worn and then acts like a contour wheel with a rounded-off tip. Although the sharp tip quickly becomes worn, it can be recreated just as quickly with a dressing wheel already located on the same tool grinding machine. The slightly worn roof ridge is then similar to a torus with a very small torus radius. On account of this very small dimension, deviations from pointed geometry or from the ideal torus are very small in absolute terms, and can consequently be tolerated. In comparison with a contour grinding wheel, a different grinding operation is carried out with the grinding wheel according to the invention: grinding is performed not only with the tip but also, i.e. primarily, with the converging roof sides.

The grinding wheels typically have a wheel diameter of 300 mm. This relatively large radius is chosen to allow planar surfaces to be ground.

Grinding and dressing can be carried out in an advantageous way on one and the same machine.

Typically, not just one of these grinding wheels but a number of them will be arranged in a tool grinding machine.

Any concave and convex profiles can be ground with the double-cone wheel according to the invention, concave radii being ground with the tip and straight portions in concave surface profiles of the cutting tool as well as all convex profiles being ground with one of the two faces. This very advantageous grinding technique on faces, as is the case in particular with cup wheels or peripheral wheels, is retained: the straight wheel contour of the double-cone wheel is easy to dress. The flat roof sides have a long service life in the grinding process and may be used in a rocking manner to improve the surface quality.

A grinding machine with such a double-cone wheel provides good workpiece accessibility, no problems with clamping means and machine paths that are small. The fitting of the machine with a number of wheels (for example coarse-grained for roughing and fine-grained for smoothing) is possible without any collisions occurring. The use of different wheels for roughing provides a greater removal rate and allows a more stable production process because there is less abrasion on the wheels, in particular fabric-reinforced wheels. The wheels then have to be dressed less, and less often. Moreover, polishing operations, which involve extremely little removal and therefore serve only for improving the surface quality, may be made to follow later in the same working program. The polishing thereby benefits from the grinding method that is proposed here, since fine-grain wheels with grain sizes in the range of just a few thousands of a millimeter tolerate only very small amounts of removal. Very precise wheel geometries and similarly precise tool geometries are a prerequisite for the polishing operation.

The following detailed description and the patent claims in their entirety provide further advantageous embodiments and combinations of features of the invention.

### BRIEF DESCRIPTION OF THE DRAWINGS

In the drawings used to explain the exemplary embodiment:

FIG. 1 shows a cross section through a configurational variant of the grinding wheel according to the invention,

FIG. 2 shows a plan view of the grinding wheel represented in FIG. 1,

FIG. 3 shows a side view of the grinding wheel represented in FIG. 1,

FIGS. 4a-4j show a schematic representation for the grinding of different surface profiles of a cutting tool with the grinding wheel represented in FIGS. 1 to 3,

FIG. 5 shows a schematic representation for dressing a grinding wheel with a dressing wheel that is arranged on the same machine tool as the grinding wheels grinding the tool, and

FIG. 6 shows a variant of the grinding wheel represented in FIGS. 1 to 3.

In principle, the same parts and elements are provided with the same designations in the figures.

### WAYS OF IMPLEMENTING THE INVENTION

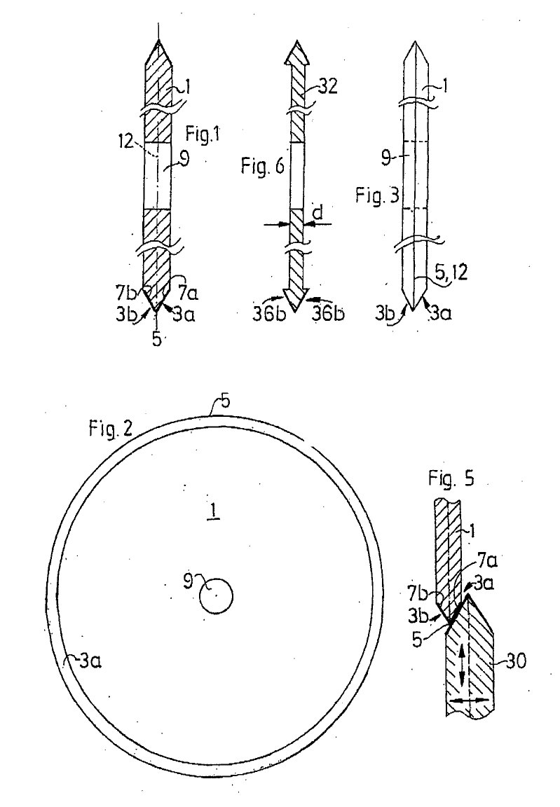

The grinding wheel 1 represented in FIGS. 1 to 3 as an exemplary embodiment of the subject matter of the invention has on the circumference of the wheel (the wheel face) two wheel edge sides 3a and 3b, which are formed as roof sides and converge to form a peripheral ridge 5. The two roof sides 3a and 3b abut at the ridge 5 at a ridge angle α. The size of the ridge angle α is based on the surface contour to be ground. The ridge angle α is generally less than 90°, typically 60°. The roof sides 3a and 3b are provided with an abrasive coat 7a and 7b, respectively. In the center of the grinding wheel 1 there is an aperture 1, to allow the wheel 1 to be fitted on a spindle (not represented) of a grinding head.

The grinding wheel 1 is made such that it is rotationally symmetrical in relation to its axis of rotation 10. The axis of rotation 10 forms the axis of the aperture 9. A plane in which the peripheral roof ridge 5 lies likewise forms a plane of symmetry 12. Together with one of the roof sides 3a and 3b, respectively, and one of the subsequently mentioned side faces 19a and 19b, respectively, the plane of symmetry 12 defines a cone [19a-3a-12 and 19b-3b-12, respectively]. The grinding wheel 1 may consequently also be referred to as a double-cone wheel, the axis of rotation 10 being identical to the axes of the cones.

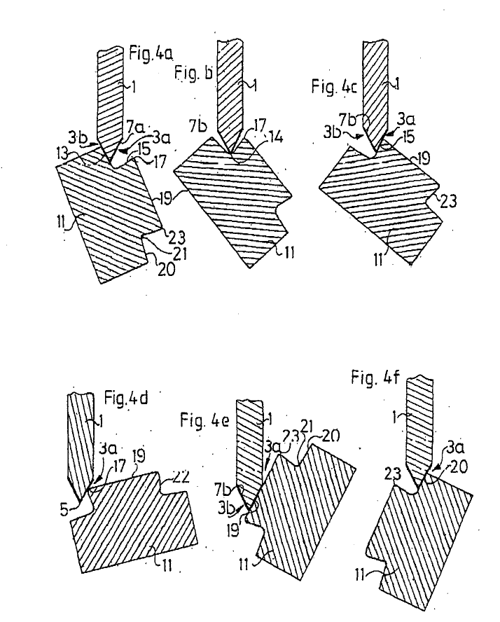

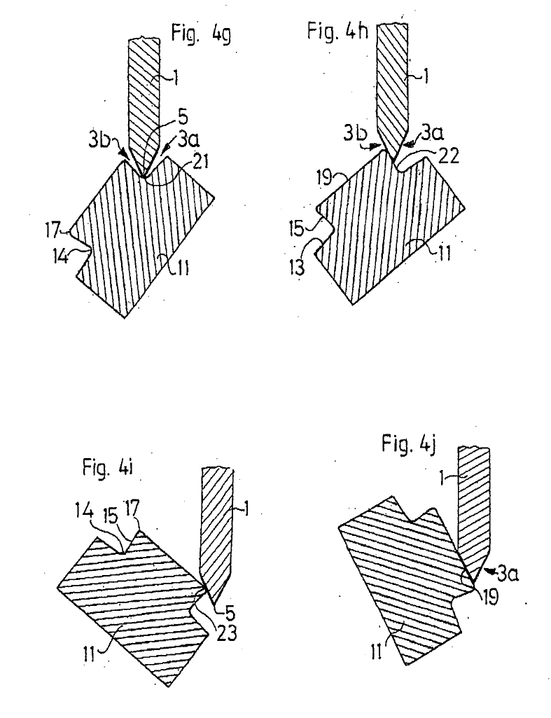

In FIGS. 4a to 4j, the respective relative position between a cutting tool 11 to be ground and the grinding wheel 1 at different surface contour regions is represented. In FIG. 4a it is shown how an approximately planar, straight-running surface contour region 15 can be ground with the roof side 3b of the grinding wheel 1. For grinding surface contours, the tool 11 to be ground is generally moved. If a ground relief 14 with a concave surface contour, as indicated in FIG. 4b, is to be ground, the roof ridge 5 of the grinding wheel 1 is used. Grinding of a then following straight or convex surface contour region 15, as represented in FIG. 4c, is performed with the roof side 3a. A convex edge 17 following the surface region 15 is also ground with the roof side 3a (FIG. 4d). The approximately planar surface region 18 following the edge 17 is also ground with the roof side 3a (FIG. 4e). After grinding the surface region 18, the tool 11 is offset. and a planar (or convexly curved) surface region 20 (FIG. 4f) is ground with the same roof side 3a. After slight turning of the tool 11, grinding of the relief 21, having a concave surface region, is performed with the roof ridge 5 (FIG. 4g).

The then following approximately straight surface region 22 of the ground relief is ground with the roof side 3b (FIG. 4h), and after that also the then following edge 23 (FIG. 4i). The already ground surface region 18 could be re-ground once again with the roof side 3b, as represented in FIG. 4j, in order to obtain a good transition from the edge 23 to the surface region 18. The surface contour regions 14 and 15 and also 21 and 22 represent a relief-ground portion.

Instead of performing the grinding operation by starting from FIG. 4e and proceeding through FIGS. 4f to 4j, it may also take place in the reverse sequence through FIGS. 4j to 4f. It should be ensured as far as possible that working is carried out with the roof sides in a drawing motion, so that the roof ridge is used as little as possible.

On a machine tool, generally a number of grinding wheels are used for the grinding of tools. In order to dress the grinding wheel 1, i.e. to grind the roof sides to a planar state after they have been used for grinding for some time, and to sharpen the roof ridge, as indicated in FIG. 5, a dressing wheel 30 is used. The dressing wheel and one or more grinding wheels 1 are located on one and the same machine tool. In other words, dressing of the grinding wheels can be performed without removing the grinding wheels from the machine tool, which saves considerable time.

The grinding wheel can then be formed as represented in FIGS. 1 to 3 as a wheel with mutually parallel side faces 19a and 19b. However, it is also possible to use not only slightly outwardly crowned side faces, as mentioned at the beginning, but also inwardly offset side faces that are crowned or planar and parallel to each other, as shown in the case of a grinding wheel 32 represented in FIG. 6. In the case of the grinding wheel 32, a base 34 of the roof sides 36a and 36b is wider than the thickness d of the grinding wheel 32. One advantage of this grinding wheel 32 over the grinding wheel 1 is the smaller dimensions, and consequently smaller mass, which allows rapid changes of the rotational frequency. In order however to achieve a uniform circumferential speed during grinding, the smaller mass means that greater requirements are demanded of a speed controlling and stabilizing system.

1. Grinding wheel (1; 32) for grinding cutting tools (11), characterized in that the circumference of the grinding wheel (1; 32) is formed as a peripheral ridge (5) with roof sides (3a, 3b; 36a, 36b) converging toward it, each having an abrasive coat (7a, 7b), it being possible for straight and convex surface contour regions (13, 15, 17, 18, 20, 22, 23) of the cutting tool (11) to be ground with one. of the roof sides (3a, 3b; 36a, 36b) and concave surface contour regions (14, 21) of the cutting tool (11) to be ground with one of the roof sides (3a, 3b; 36a, 36b) or the ridge (5).

2. Grinding wheel (1; 32) according to claim 1, characterized in that the grinding wheel (1; 32) is formed as a double-cone wheel, an axis of rotation (10) coinciding with the axes of the cones.

3. Grinding wheel according to claim 1, characterized in that the roof sides (3a, 3b; 36a, 36b) are formed as respective planes, which are at an angle (α) of less than 90°.

4. Machine tool for grinding cutting tools (11) with a grinding head which has at least one grinding wheel (1; 32), characterized in that the circumference of the grinding wheel (1; 32) is formed as a peripheral ridge (5) with roof sides (3a, 3b; 36a, 36b) converging toward it, each having an abrasive coat (7a, 7b), it being possible for straight and convex surface contour regions (13, 15, 17, 18, 20, 22, 23) of the cutting tool (11) to be ground with one of the roof sides (3a, 3b; 36a, 36b) and concave surface contour regions (14, 21) of the cutting tool (11) to be ground with one of the roof sides (3a, 3b; 36a, 36b) or the ridge (5).

5. Machine tool according to claim 4, characterized in that the grinding wheel (1; 32) is formed as a double-cone wheel, an axis of rotation (10) of the grinding wheel (1; 32) coinciding with the axes of the cones and a spindle axis of the machine tool.

6. Machine tool according to claim 4, characterized in that the roof sides (3a, 3b; 36a, 36b) are formed as respective planes, which are at an angle (α) of less than 90°.

7. Machine tool according to claim 4, characterized by at least one dressing wheel (30), with which at least one of the roof sides (3a, 3b; 36a, 36b) can be dressed, preferably to a planar state.

8. Machine tool according to claim 4, characterized in that a number of these grinding wheels (1; 32) are present, preferably with different wheel thicknesses, in particular with abrasive coats (7a, 7b) having different abrasive grain sizes, and preferably with different ridge angles (α).

9. Method for grinding cutting tools (11), characterized in that, with one and the same grinding wheel (1; 32), straight portions (13, 15, 18, 20, 22) in concave surface contour regions of a cutting tool (11) respectively to be dressed are ground with roof sides (3a, 3b; 36a, 36b) that converge to a ridge (5) running peripherally around the edge of the wheel and each have an abrasive coat (7a, 7b), and all convex contour regions (17, 23) are ground with one of the two roof sides (3a, 3b; 36a, 36b) that converge to the ridge (5), and concave radii in surface contours (14; 21) of a cutting tool (11) are ground with the ridge (5) and/or one of the roof sides (3a, 3b; 36a, 36b).

10. Method according to claim 9, characterized in that dressing of this grinding wheel (1; 32) is performed on the machine tool provided for grinding the cutting tool (11), in that the roof sides (3a, 3b; 36a, 36b) are dressed to a planar state.

11. Grinding wheel according to claim 2, characterized in that the roof sides (3a, 3b; 36a, 36b) are formed as respective planes, which are at an angle (α) of less than 90°.

12. Machine tool according to claim 5, characterized in that the roof sides (3a, 3b; 36a, 36b) are formed as respective planes, which are at an angle (α) of less than 90°.

13. Machine tool according to claim 5, characterized by at least one dressing wheel (30), with which at least one of the roof sides (3a, 3b; 36a, 36b) can be dressed, preferably to a planar state.

14. Machine tool according to claim 6, characterized by at least one dressing wheel (30), with which at least one of the roof sides (3a, 3b; 36a, 36b) can be dressed, preferably to a planar state.

15. Machine tool according to claim 5, characterized in that a number of these grinding wheels (1; 32) are present, preferably with different wheel thicknesses, in particular with abrasive coats (7a, 7b) having different abrasive grain sizes, and preferably with different ridge angles (α).

16. Machine tool according to claim 6, characterized in that a number of these grinding wheels (1; 32) are present, preferably with different wheel thicknesses, in particular with abrasive coats (7a, 7b) having different abrasive grain sizes, and preferably with different ridge angles (α).

17. Machine tool according to claim 7, characterized in that a number of these grinding wheels (1; 32) are present, preferably with different wheel thicknesses, in particular with abrasive coats (7a, 7b) having different abrasive grain sizes, and preferably with different ridge angles (α).
